(19) United States
(12) Patent Application Publication
(10) Pub. No.: US 2025/0327337 A1
(43) Pub. Date: Oct. 23, 2025

(54) Clutch module for electronic locks

(71) Applicant: U-TEC GROUP INC., Union City, CA (US)

(72) Inventor: Lingling QIAN, Union City, CA (US)

(73) Assignee: U-TEC GROUP INC., Union City, CA (US)

(21) Appl. No.: 18/643,155

(22) Filed: Apr. 23, 2024

(51) Int. Cl. E05B 47/00

(52) U.S. Cl. CPC E05B 47/0012; E05B 47/0607; E05B 47/0692; E05B 2047/0026

(57) ABSTRACT

The present invention relates to the field of lock technology, specifically a clutch module for electronic locks. The present invention uses motor rotation and transmission to move latch pushing pieces back and forth to drive optical coupling induction pieces and optical couplers to act together, thereby transmitting information to engage latches into rear clutch components. The present invention ensures a stable power source, reasonable transmission, timely and precise judgment of latch status, thereby ensuring the stable operation of entire clutches and guaranteeing overall operation of locks, which eliminates the need for excessive disassembly and repair, and enhances lifespan of devices.

### TECHNICAL FIELD

The present invention relates to the field of lock technology, specifically a clutch module for electronic locks.

### BACKGROUND TECHNOLOGY

Electronic lock clutches are devices used to control separation and closing between lock bodies and handles. When in use, motors drive connecting pins inside clutches to engage with square shafts of handles, handles are rotated to drive clutches, and then lock tongues are driven to achieve unlocking.

Electronic lock clutches in the prior art suffer from unclear current engagement status of the front and rear clutches, resulting in unstable operation and frequent lock failures; and disassembly and assembly thereof are troublesome, impacting normal and stable usage.

Based on the aforementioned reasons, the present invention proposes a clutch module for electronic locks, which uses motor rotation and transmission to move latch pushing pieces back and forth to drive optical coupling induction pieces and optical couplers to act together, thereby transmitting information to engage latches into rear clutch components and effectively achieving locking and unlocking.

### SUMMARY OF THE INVENTION

In order to overcome shortcomings of existing technology, the present invention provides a clutch module for electronic locks, which uses motor rotation and transmission to move latch pushing pieces back and forth to drive optical coupling induction pieces and optical couplers to act together, thereby transmitting information to engage latches into rear clutch components and effectively achieving locking and unlocking.

The present invention provides a clutch module for electronic locks, comprising an upper clutch shell, an outer clutch shell and a bottom clutch shell, wherein inside the outer clutch shell comprises at least one motor, at least one optical coupler, a rear clutch component and a front clutch component, the rear clutch component is installed in the front clutch component, on a motor shaft of the at least one motor is installed at least one motor shaft sleeve, on the at least one motor shaft sleeve is provided at least one pusher spring, at least one pusher limit pin and at least one latch push piece for pushing at least one latch, on one side of the at least one latch push piece is installed at least one optical coupling induction piece, inside the outer clutch shell is installed at least one optical coupler cooperating with the at least one optical coupling induction piece, inside the front clutch component is installed at least one latch sleeve for fixing the at least one latch, inside the at least one latch sleeve is installed the at least one latch, and inside the at least one latch is provided at least one latch return spring for drive the at least one latch to reset.

Further, at a top portion of the outer clutch shell is installed the upper clutch shell through buckle structures.

Further, at a bottom portion of the outer clutch shell is installed the bottom clutch shell through buckle structures for fixing the front clutch component.

Further, the front clutch component is used for linking with front handles of a door lock.

Further, inside the outer clutch shell are provided ribs for reducing movement friction resistance of the at least one latch push piece, positioning ribs and movement clearance ribs.

Compared to the prior art, the present invention uses motor rotation and transmission to move latch pushing pieces back and forth to drive optical coupling induction pieces and optical couplers to act together, thereby transmitting information to engage latches into rear clutch components and effectively achieving locking and unlocking. Furthermore, due to the real-time status feedback of the photo-coupler combination to an electronic lock control module, the internal condition of the clutch module can be monitored.

The present invention ensures a stable power source, reasonable transmission, timely and precise judgment of latch status, thereby ensuring the stable operation of entire clutches and guaranteeing overall operation of locks, which eliminates the need for excessive disassembly and repair, and enhances lifespan of devices.

### BRIEF DESCRIPTION OF THE DRAWINGS

FIG. 1 is a schematic diagram showing appearance of a clutch module for electronic locks of the present invention.

FIG. 2 is a schematic diagram showing disassembled structures of the clutch module for electronic locks of the present invention.

FIG. 3 is a schematic diagram showing assembled structures of the clutch module for electronic locks of the present invention.

The markups in the drawings are indicated as follows:
1—clutch upper shell;
2—motor;
3—motor shaft sleeve;
4—pusher spring;
5—pusher limit pin;
6—latch push piece;
7—optical coupling induction piece;
8—optical coupler;
9—latch;
10—latch sleeve;
11—latch return spring;
12—outer clutch shell;
13—rear clutch component;
14—front clutch component; and
15—bottom clutch shell.

### SPECIFIC EMBODIMENTS

The present invention is further described in conjunction with the attached drawings.

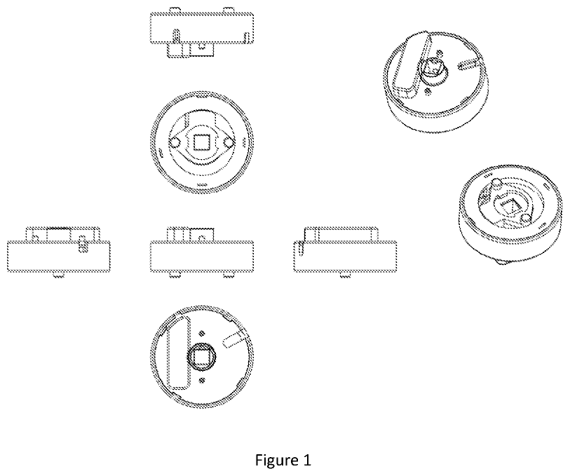

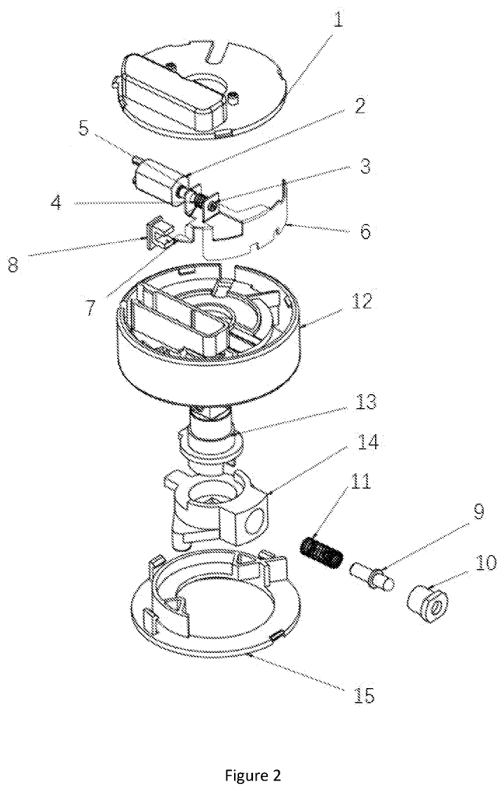

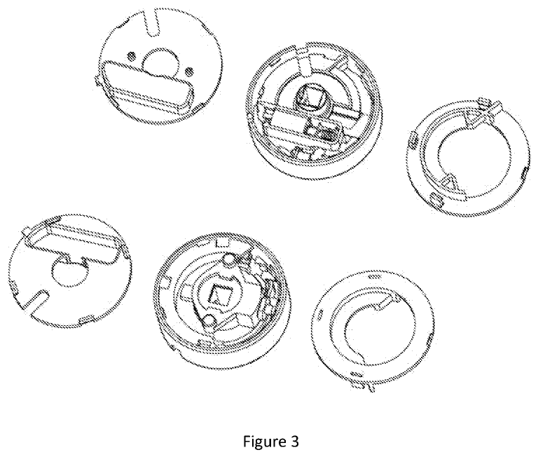

Please refer to FIGS. 1-3, the present invention provides a clutch module for electronic locks, comprising an upper clutch shell 1, an outer clutch shell 12 and a bottom clutch shell 15, wherein inside the outer clutch shell comprises at least one motor 2, at least one optical coupler 8, a rear clutch component 13 and a front clutch component 14, the rear clutch component 13 is installed in the front clutch component 14, on a motor shaft of the at least one motor 2 is installed at least one motor shaft sleeve 3, on the at least one motor shaft sleeve 3 is provided at least one pusher spring 4, at least one pusher limit pin 5 and at least one latch push piece 6 for pushing at least one latch 9, the at least one pusher spring 4 serves to cooperate with the at least one pusher limit pin 5 to drive the at least one latch push piece 6 to move back and forth, and the at least one pusher limit pin 5 is to limit forward and backward travels of the at least one latch push piece 6, on one side of the at least one latch push piece 6 is installed at least one optical coupling induction piece 7, inside the outer clutch shell 12 is installed at least one optical coupler 8 cooperating with the at least one optical coupling induction piece 7, inside the front clutch component 14 is installed at least one latch sleeve 10 for fixing the at least one latch 9, inside the at least one latch sleeve is installed the at least one latch 9, the at least one latch 9 enables the front clutch component 14 to drive the rear clutch component 13 to move together, and inside the at least one latch 9 is provided at least one latch return spring 11 for drive the at least one latch 9 to reset.

Further, at a top portion of the outer clutch shell 12 is installed the upper clutch shell 12 through buckle structures.

Further, at a bottom portion of the outer clutch shell 12 is installed the bottom clutch shell 15 through buckle structures for fixing the front clutch component 14.

Further, the front clutch component 14 is used for linking with front handles of a door lock.

Further, inside the outer clutch shell 12 are provided ribs for reducing movement friction resistance of the at least one latch push piece 6, positioning ribs and movement clearance ribs.

The working principle of the present invention is as follows:

When in standby mode, the front clutch component 14 and rear clutch component 13 are disengaged; when the at least one motor 2 receives a signal command from a control module of an electronic lock, the at least one motor 2 starts rotating to drive the at least one motor shaft sleeve 3 into rotational motion, the at least one motor shaft sleeve 3 then drives the at least one pusher limit pin 5 to perform rotational motion, which in turn moves the at least one pusher spring 4 forward or backward, and then the at least one pusher spring 4 drives the at least one latch push piece 6 to move forward or backward, simultaneously, the at least one optical coupling induction piece 7 also moves forward or backward, the at least one latch push piece 6 drives the at least one latch 9 to move inward, and at this point the at least one latch 9 enters the rear clutch component 13; when the at least one optical coupling induction piece 7 reaches the position of the at least one optical coupler 8, the at least one optical coupler 8 simultaneously feeds back information to the control module of the electronic lock, indicating that the at least one latch 9 has completely entered the rear clutch component 13, at this point, the at least one motor 2 stops working, and the front clutch component 14 is linked with the rear clutch component 13, the rear clutch component 13 then drives a square rod and a lock tongue on the square rod to perform locking and unlocking actions; and when the at least one latch push piece 6 moves in an opposite direction, the at least one latch 9, under the action of the at least one latch reset spring 11, will disengage from the rear clutch component 13, preventing the front clutch component 14 from being linked with the rear clutch component 13, thus disabling the locking and unlocking actions.

The above are only preferred embodiments of the present invention, and are only used to help understand the method and core idea of the present invention. The protection scope of the present invention is not limited to the above-mentioned embodiments, and all technical solutions falling under the idea of the present invention belong to the protection scope of the present invention. It should be pointed out that for those of ordinary skill in the art, several improvements and modifications may be made without departing from the principles of the present invention, and these improvements and modifications should also be regarded as the protection scope of the present invention.

In the description of the present invention, it should be noted that directional or positional relationships indicated by terms such as “upper,” “lower,” “inner,” “outer,” etc., are based on the orientation or positional relationships shown in the drawings. These are provided solely to facilitate the description of the present invention and to simplify the description, rather than to indicate or imply that the device or component referred to must have a specific orientation, be constructed and operated in a specific orientation, which therefore should not be construed as limiting the present invention.

The present invention overall resolves the issues that electronic lock clutches in the prior art suffer from unclear current engagement status of the front and rear clutches, resulting in unstable operation and frequent lock failures; and disassembly and assembly thereof are troublesome, impacting normal and stable usage; the present invention uses motor rotation and transmission to move latch pushing pieces back and forth to drive optical coupling induction pieces and optical couplers to act together, thereby transmitting information to engage latches into rear clutch components, and achieving locking and unlocking, which guarantees the overall operation of a lock, eliminates the need for excessive disassembly and repair, and enhances lifespan of devices.

1. A clutch module for electronic locks, comprising an upper clutch shell (1), an outer clutch shell (12) and a bottom clutch shell (15), wherein inside the outer clutch shell there are at least one motor (2), at least one optical coupler (8), a rear clutch component (13) and a front clutch component (14), the rear clutch component (13) is installed in the front clutch component (14), on a motor shaft of the at least one motor (2) is installed at least one motor shaft sleeve (3), on the at least one motor shaft sleeve (3) is provided at least one pusher spring (4), at least one pusher limit pin (5) and at least one latch push piece (6) for pushing at least one latch (9), on one side of the at least one latch push piece (6) is installed at least one optical coupling induction piece (7), inside the outer clutch shell (12) is installed at least one optical coupler (8) cooperating with the at least one optical coupling induction piece (7), inside the front clutch component (14) is installed at least one latch sleeve (10) for fixing the at least one latch (9), inside the at least one latch sleeve is installed the at least one latch (9), and inside the at least one latch (9) is provided at least one latch return spring (11) for drive the at least one latch (9) to reset.

2. The clutch module for electronic locks according to claim 1, wherein at a top portion of the outer clutch shell (12) is installed the upper clutch shell (12) through buckle structures.

3. The clutch module for electronic locks according to claim 1, wherein at a bottom portion of the outer clutch shell (12) is installed the bottom clutch shell (15) through buckle structures for fixing the front clutch component (14).

4. The clutch module for electronic locks according to claim 1, wherein the front clutch component (14) is used for linking with front handles of a door lock.

5. The clutch module for electronic locks according to claim 1, wherein inside the outer clutch shell (12) are provided ribs for reducing movement friction resistance of the at least one latch push piece (6), positioning ribs and movement clearance ribs.
